(19) United States
(12) Patent Application Publication
(10) Pub. No.: US 2004/0031525 A1
(43) Pub. Date: Feb. 19, 2004

(54) Secondary stage regulator apparatus and method for regulating compressed air thereof

(76) Inventor: Daniel H. Colby, Elk Grove Village, IL (US)

Correspondence Address: Jeffrey A. Pine, BANIAK PINE & GANNON, 150 N. Wacker Drive, Suite 1200, Chicago, IL, 60606-1606, US

(21) Appl. No.: 10/600,071

(22) Filed: Jun. 20, 2003

Related U.S. Application Data
(63) Continuation of application No. 09/899,506, filed on Jul. 5, 2001, now abandoned.
(60) Provisional application No. 60/216,268, filed on Jul. 6, 2000.

(51) Int. Cl. G05D 16/04

(52) U.S. Cl. 137/505.42

(57) ABSTRACT

A secondary stage regulator is disclosed wherein a piston-type configuration is utilized to regulate an input working pressure as high as 1,200 PSI, to an output delivery pressure from 50 PSI to 900 PSI. The secondary stage regulator can be used on paintball guns, markers and similar devices powered by compressed gas.

### TECHNICAL FIELD OF THE INVENTION

The present invention relates to a regulator apparatus for regulating an output delivery pressure, and more particularly, the present invention relates to a regulator configured to be attached to a paintball gun or a marker for receiving input working pressure of up to 1,200 pounds per square inch (PSI), and regulating the output delivery pressure from approximately 50 PSI to about 900 PSI. The regulator of the present invention has the ability to be adjusted by a player to increase or decrease the output delivery pressure.

### BACKGROUND OF THE INVENTION

In recent years, as the popularity of paintball games has grown, there has been a proliferation of different types of paintball guns, air guns or markers, and the devices that are used in conjunction with these markers. These new markers and related devices have become necessary due to the increased level of play as players improve and hone their skills.

The early types of markers and related devices provided an adequate level of play. However, the onset of more experienced players, along with challenging paintball gun tournaments, now provides an arena where better markers and peripherals are required to sufficiently compete.

As such, there is a great need for devices that speed up a players level of play while still providing the necessary accuracy needed during play. Further, there is a need for a device that allows a player certain capabilities before, during, and after competitions and tournaments. Some of these capabilities include the ability to adjust the output pressure level, and the ability to easily remove pressure vessels under full pressure.

Also, a need exists for a device that allows for the removal of a pressure vessel, under full pressure, so that the vessel can be recharged or filled, and returned to the marker at a later time. The ability to remove the pressure vessel would allow for transportation and storage of the Marker and operating components in a compact and disassembled mode. More importantly, there is a need for the player to be able to place a different vessel onto the marker while in full play conditions under severe time constraints. This capability addresses the need that arises during different games, such as speedball, wooded, heavy terrain, etc.

Further, because players may be right-handed or left-handed there is a need for a regulator that can be adapted or converted for a right- or left-hand player. In other words, there is a need for a regulator that allows the unregulated pressure inlet hose to be placed on either side of the pistol grip. A regulator's mounting system must also have the ability to provide ease of bi-directional attachment for the regulator system, so that the regulator system can be adjusted to the player's arm length and playing style.

Another problem is the natural decay curve associated with pneumatic regulators. The natural decay curve exists when the regulator is set while the pressure in the pressure vessel is at the maximum capacity a determined amount of energy is applied to the main spring of the regulator. This energy is offset by manually adjusting the tension (spring energy) by the player to achieve the desired output pressure. As pressure in the pressure vessel decreases through use, the initial energy value changes (decreases) and unless the player manually decreases main spring tension (spring energy), the proportion of pressure vessel energy and main spring energy no longer stay in proportion to give the desired amount of output pressure. The output side of the regulator sees an increase in the output pressure.

Utilizing a dual regulated configuration can negate the natural decay curve. However, the use of a dual regulated configuration lends to another problem, which is the systems (primary and secondary regulators in conjunction with an interface between them) lack the ability to flow sufficient amounts of regulated air as required by the marker.

There is a need for such a high-precision regulator that incorporates these inadequacies found in many of the current regulators.

### SUMMARY OF THE INVENTION

Accordingly, the main object of the present invention is to provide a secondary stage regulator that addresses the above listed disadvantages and others.

The secondary stage regulator of the present invention is a high quality, cost affordable, secondary stage regulator designed to accept inlet pressures as high as 1,200 pounds PSI. The outlet pressure of the secondary stage regulator ranges from 50 to 900 PSI. The outlet pressure is pre-adjusted at the factory to a 750 PSI base line and can be adjusted by the player to meet his markers particular needs. The present invention has been equipped with industry standard Compressed Gas Association (CGA) 320 male threads to securely semi permanently insert or mount the gas distribution body of the present invention into or onto a player's marker.

The present invention relates to a secondary stage regulator having a piston-type configuration that accepts an input working pressure of up to 1,200 PSI and is designed to regulate the output delivery pressure from about 50 PSI to 900 PSI, provided the input pressure is sufficient. The secondary stage regulator is designed such that the player or user of the regulator can determine the appropriate output delivery pressures best suited for their particular configuration.

The secondary stage regulator includes a piston housing, a gas distribution body, and a tournament cap. The gas distribution body, the piston housing, and tournament cap are preferably aluminum, however in an alternative embodiment may be constructed from stainless steel or other high tensile material. The gas distribution body and the piston housing houses a pin spring, a pin, a seat, a washer, if needed, a piston, a compression spring, a spacer, and an adjustment nut. The gas distribution body and the piston housing contain various O-rings as needed.

It is another aspect of the present invention to provide a pneumatic regulator wherein player can remove his current pressure vessel and the corresponding valve body assembly and replace it with another pressure vessel without a dramatic change in the output pressure that is provided to the marker. The result is no negative impact or impedance of the marker that the player is using.

It is yet another aspect of the present invention to provide a secondary stage regulator having two inlet ports, one on either side of the main body assembly of the regulator. Such an arrangement allows the player to attach the inlet hose to either side of the marker by utilizing one of the output ports, depending on the preference of the player.

It is yet another aspect of the present invention to provide a secondary stage regulator comprising a piston with a pressure relief mode, which provides an additional safety measure when the high-pressure compressed gas becomes excessive.

It is a final aspect of the present invention to provide a secondary stage regulator that is designed and configured to allow the present invention that can be operated as a single stage regulator when the present invention provides primary regulation.

### BRIEF DESCRIPTION OF THE DRAWINGS

FIG. 1 is a side view of a pneumatic regulator for markers in accordance with the present invention;

FIG. 2 is an exploded sectional view of internal components of a piston housing of the pneumatic regulator for markers in accordance with the present invention;

FIG. 3 is an exploded sectional view of internal components of the gas distribution body potion of the pneumatic regulator in accordance with the present invention; and

FIG. 4 is a side view of the pneumatic regulator constructed and fastened to a marker and a high pressure bottle in accordance with the present invention.

### DETAILED DESCRIPTION OF THE PREFERRED EMBODIMENTS

The present invention is a secondary stage regulator, designed to accept input working pressures up to 1,200 PSI, and designed to regulate an output pressure range of between 50 and 900 PSI, however the preferred embodiment has an outlet pressure of 750 PSI. The present invention is compatible with virtually all of the paintball guns or markers currently used in the sport of Paintball. The preferred embodiment of the present invention incorporates high and low side pressure safety methods and ambidextrous hose input. The majority of the composition of the preferred embodiment is high strength aerospace grade aluminum alloy.

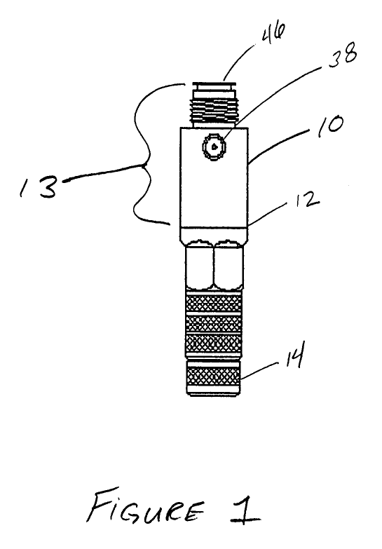

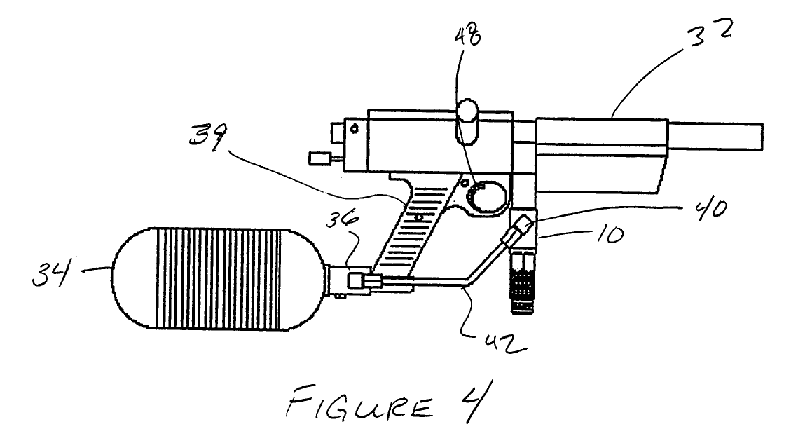

FIG. 1 shows a side view of a secondary stage regulator 10 for a marker (not shown) in accordance with the present invention. As will be described in detail herein, the pneumatic regulator 10 is located between a marker (not shown) and a pressure vessel with a valve/regulator interface (not shown). A piston housing 12, a gas distribution body 13, and a tournament cap 14 make up the majority of the exterior of the secondary stage regulator. The regulator 10 described within the preferred embodiments has two inlet pressure ports (not shown) on each side of the regulator 10. The dual inlet pressure ports allow for connecting an input hose from the pressure vessel 34 (e.g. FIG. 4) and primary valve regulator 35 to either side of the regulator 10 thus creating ambidextrous installation capabilities. The regulator 10 receives pressurized air at one of two inlet ports (not shown), and delivers regulated air out of a single outlet port 46 to the marker 32.

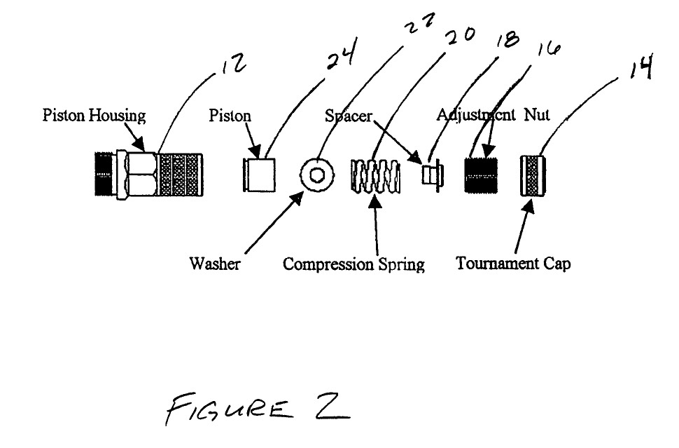

FIG. 2 shows an exploded sectional view of internal components of a piston housing portion of the pneumatic regulator covered in accordance with the present invention. Components located within the piston housing are an adjustment nut 16, a spacer 18, a compression spring 20, a washer 22, if needed, and a piston 24. However in an alternative embodiment, the regulator could utilize two spacers or other methods of controlling compression spring activity.

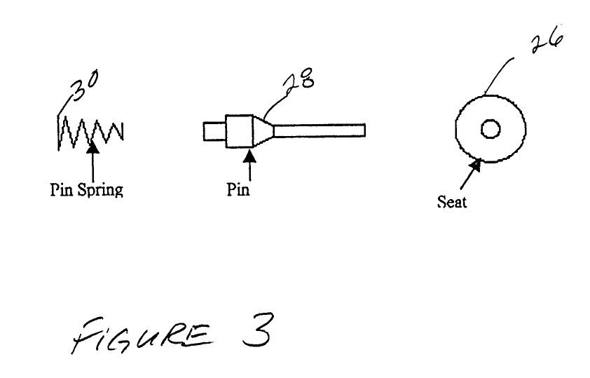

FIG. 3 shows an exploded sectional view of internal components of a gas distribution body 13 (e.g. FIG. 1) of the regulator 10 for markers 32 in accordance with the present invention. These internal components are a seat 26, a pin 28, and a pin spring 30. The pin spring 30 is placed into the gas distribution body 13 inside the regulator 10. The pin 28 is also placed inside gas distribution body 13, such that the end of the pin 28 makes contact with the pin spring 30. The pin spring 30, the pin 28, and the seat 26 are configured and positioned inside the gas distribution body 13, such that the pin spring 30 forces the pin 28 towards the seat 26.

After the pin spring 30, the pin 28, and the seat 26 are positioned within said gas distribution body 13, the remainder of the regulator 10 can be assembled. Next, the piston 24 (e.g. FIG. 2) is placed into the piston housing 12 followed by the washer 22, the compression spring 20, and the spacer 18. These internal components are held within the regulator 10 by use of an adjustment nut 16. Attaching the tournament cap 14 to the regulator adjustment nut 16 locks the output pressure adjustment to prevent an accidental increase or decrease in pressure. Doing so completes the assembly of the regulator.

Additionally, the invention utilizes O-rings to maintain the pneumatic pressure within the invention. For clarity purposes, the O-rings are not shown or discussed, but are well understood by one having ordinary skill in the art.

A safety burst disk (not shown) is positioned in a safety burst disk port 38. If the pressure in the regulator 10 becomes too great, the safety burst disk will release from the safety burst disk port 38 as understood by one having ordinary skill in the art. When the safety burst disk releases, gas escapes through the port, reducing the pressure in the regulator. In accordance with current Compressed Gas Association (CGA) safety standard recommendations, the burst disk should release at 1.5 times the input pressure rating. For a system in which the input pressure rating is 1,200 PSI, thus the burst disk should release if the input pressure reaches about 1,800 PSI.

FIG. 4 shows a marker 32, a pressure vessel 34, and the regulator 10 connected and ready to be used. First the regulator 10 must be mounted and pneumatically connected to the marker 32. Next, the primary valve regulator 36 of the pressure vessel 34 must be pneumatically connected to the regulator 10. The pressure vessel 34 can be attached to one of two inlet ports 40, one on either side of the main body assembly of the regulator 10. Such an arrangement allows the player to attach the inlet hose 42 to either side of the marker by utilizing one of the inlet ports 40, depending on the preference of the player. The system is now ready to be used.

In one form of the preferred embodiment the pressure vessel 34 is secured to the pistol grip 39 of the marker 32. In another form of the preferred embodiment the pressure vessel 34 is not secured to the pistol grip 38 of the marker 32.

Referring back to figures FIGS. 1 through 4, the operation of the pneumatic regulator of the present invention can be understood. Once the adjustment nut 16 is rotatively positioned for the proper output pressure, the regulator 10 is operationally described below. It should be noted that the adjustment nut 16 can be accessed for adjustment even after the regulator 10, the marker 32, and the pressure vessel 34 are connected and pressurized.

When the system is assembled, the regulator 10 has pressurized gas applied to one of the dual inlet ports 40. The pressurized gas flows over the pin spring 28 and against the pin 28. The pressurized air crosses over the pin 28 and applies pressure to the piston 24 that in turn transfers the energy to the compression spring 20. The position of the adjustment nut 16 determines the amount of available stored energy of the compression spring 20 thus determining the output pressure of the regulator 10. This stored energy of the compression spring 20 is applied to pressurized air being delivered to the regulator 10 via the piston 24. Simultaneously air pressure is applied to the piston safety (not shown) located within the piston 24. The piston safety is designed to relieve pressure through a bleeding off of excessive output pressure if the system reaches a critical output pressure that may render the marker 32 inoperative. Regulated air pressure is transferred to the piston area (not shown) and also to the low pressure safety disk (not shown) in the low pressure safety port (e.g. FIG. 1). This low pressure safety is also designed to prevent over pressurization of the regulator just as the piston safety does.

When a trigger 48 on the marker 32 is depressed an imbalance in air pressure is sensed on the output side of the regulator 10. As air pressure in the regulator 10 drops, the energy of the compression spring 20 pushes the piston 24 forward depressing the pin 28 and compressing the pin spring 30, thus unseating pin 28 from a seat 26, located within the gas distribution body 13. Once the pin 28 is unseated, a pre-determined amount of pressurized gas can escape from the pressure vessel 34 through the opening left by the unseated pin 28, and into the piston area (not shown). The pre-determined amount of propellant, and the related regulated pressure, will be dependent on the distance that the pin 28 is unseated, which in turn is dependent on how far the adjustment nut 16 has “pushed” the piston 24 towards the pin 28.

Once the pre-determined amount of propellant flows into the piston area (not shown), the pressurized propellant assists the compression spring 20 to moves the piston 24 back in to the original position. This return to the original position allows the pin 28 to reseat in the seat 26, thus shutting off propellant flow from the pressure vessel 34. The marker system is now pressurized and ready to fire.

When the player pulls the trigger 48 on the marker 32, a demand is created for the propellant gas. The propellant travels from the piston area (not shown) out a single outlet port 46 (e.g., FIG. 1) and into the marker 32. The configuration of the marker 32 is such that the propellant forces or expels a paint ball (not shown) from the marker 32.

Once the propellant exits the piston area (not shown), the pressure therein is reduced. This reduction in pressure allows the compression spring 20 to force the piston 24 back towards the pin 28. When the piston 24 moves in this direction, the piston 24 again makes contact with the pin 28, which in turn unseats the pin 28 from the seat 26, thereby allowing the main body assembly to again fill with a pre-determined amount of propellant.

It can be seen that this process can occur at high speeds and, depending on the marker 32, the regulator 10 can provide propellant to the marker 32 that will allow the marker 32 to expel many paint balls per second.

As described above, the regulated output delivery pressure is adjusted with the adjustment nut 16, located in the regulator 10 under the locking tournament cap 14. In the preferred embodiment, the tournament cap 14 can be removed and the adjustment nut 16 can be turned clockwise, thereby increasing the regulated output pressure. Turning the adjustment nut 16, counter-clockwise, reduces the regulated output pressure.

If the player's playing style requires that the regulated input hose 42 be switched to the opposite side of the marker, the regulator input pressure fitting is easily swapped from side to side.

The foregoing detailed description of the invention is intended to be illustrative and not intended to limit the scope of the invention. Changes and modifications are possible with respect to the foregoing description, and it is understood that the invention may be practiced otherwise than that specifically described herein and still be within the scope of the claims.

1. A secondary stage regulator for use on a marker, comprising:
a regulator housing, said regulator housing comprises a piston housing, a gas distribution body, a tournament cap, an adjustment nut, a spacer, a compression spring, a piston, a pin, a pin spring, and a seat,
said regulator housing is configured such that when said piston is inserted in to said piston housing, said pin is positioned within said seat and said piston is positioned against said pin that is supported by said pin spring,
said compression spring and said adjustment nut are inserted into said piston housing, respectively, said adjustment nut being located inside of and extending out of said piston housing, said adjustment nut is capable of being rotated to adjust said outlet pressure of said regulator.

2. A method for operating a secondary stage regulator on a marker, said secondary stage regulator having a regulator housing, said regulator housing comprises a piston housing and a gas distribution body, a tournament cap, an adjustment nut, a spacer, a compression spring, a piston, a pin, a pin spring, and a seat, said regulator housing is configured such that when said piston is inserted in to said piston housing, said pin is positioned within said seat and said piston is positioned against said pin that is supported by said pin spring, said compression spring and said adjustment nut are inserted into a piston area of said piston housing, respectively, said adjustment nut being located inside of and extending out of said piston housing, said adjustment nut is capable of being rotated to adjust said outlet pressure of said regulator, wherein the method comprises the steps of:
applying and transferring a pressurized gas from a pressure vessel to said marker to an inlet port of said regulator, said pressurized gas flows into said gas distribution body and through said piston housing,
unseating said pin from said seat by expansion of said compression spring,
transferring a predetermined and adjusted pressurized gas into said piston area thus,
compressing said compression ring by the change of pressure within said piston area,
reseating said pin to said seat to result in a pressurized piston area,
exhausting said pressurized piston area to said marker to propel a paintball,
reapplying and retransferring said pressurized gas from said pressure vessel to said marker to said inlet port of said regulator and,
repeating the above steps, as needed, to propel a plurality of paintballs from said marker.
